(19) United States
(12) Patent Application Publication
(10) Pub. No.: US 2026/0279879 A1
(43) Pub. Date: Sep. 17, 2026

(54) MANUFACTURING APPARATUS OF BATTERY CELL, MANUFACTURING METHOD THEREOF, AND MASTER BLOCK

(71) Applicant: SK On Co., Ltd., Seoul (KR)

(72) Inventors: Ju Hwan LEE, Daejeon (KR); Hyung Joon KIM, Daejeon (KR); Hwan Cheol YOU, Daejeon (KR); Gil Yong CHOI, Daejeon (KR); Yong Ki CHOI, Daejeon (KR)

(21) Appl. No.: 19/566,190

(22) Filed: Mar. 13, 2026

(30) Foreign Application Priority Data
Mar. 14, 2025 (KR) 10-2025-0033458

(51) Int. Cl. H01M 10/04; H01M 50/105

(52) U.S. Cl. CPC H01M 10/0404; H01M 10/0481; H01M 10/049; H01M 50/105

(57) ABSTRACT

A manufacturing apparatus of a battery cell is disclosed. The manufacturing apparatus of a battery cell includes: a cell transfer part including a carrier; a folding apparatus including a plurality of folding process parts; a master block mounted on the carrier and used to adjust a reference origin; a storage part storing a working position; and a controller controlling driving of the cell transfer part and the plurality of folding process parts, with positions of the plurality of folding process parts set to a respective working positions, wherein the working position is set by the reference origin and a preset offset value, and the reference origin is set by moving each folding process part toward the master block and bringing each folding process part into contact with the master block.

### CROSS-REFERENCE TO RELATED APPLICATION(S)

This patent document claims the priority and benefits of Korean Patent Application No. 10-2025-0033458 filed on Mar. 14, 2025, the disclosure of which is incorporated herein by reference in its entirety.

### TECHNICAL FIELD

The disclosure and implementations disclosed in this patent document generally relate to a manufacturing apparatus of a battery cell (secondary battery) capable of being charged and discharged, a manufacturing method of a battery cell, and a master block provided therefor.

### BACKGROUND

Unlike primary batteries, secondary battery cells offer the convenience of being able to be charged and discharged repeatedly. Because of this advantage, secondary battery cells are receiving significant attention as a power source for various mobile devices, electric vehicles, energy storage systems, and the like.

Secondary battery cells may be manufactured as pouch-type cells or can-type cells. The pouch-type cell has a structure in which an electrode assembly is accommodated inside flexible cell case (pouch). The can-type cell has a structure in which an electrode assembly is accommodated inside a rigid cell case (can) and may be configured as a cylindrical cell, a prismatic cell, a coin-type cell, or the like.

The pouch-type cell case includes an electrode accommodating portion accommodating the electrode assembly, and a terrace disposed on at least a portion of a periphery of the electrode accommodating portion and having a shape extending outwardly from the electrode accommodating portion. A partial region of the terrace forms a sealing portion by heat-sealing (pressing) an inner layer of the cell case. The sealing portion seals the electrode accommodating portion from the outside.

### SUMMARY

In the pouch-type battery cell, a width of the sealing portion needs to be secured to be equal to or greater than a predetermined length in order to isolate the electrode accommodating portion from the outside. When the width of the sealing portion increases, the overall volume of the battery cell increases, which may adversely affect the energy density of the battery cell. Therefore, generally, in the battery cell manufacturing process, a process of folding the terrace disposed in a position in which an electrode lead is not disposed may be performed.

A folding apparatus of folding a terrace of a battery cell may include a plurality of folding process parts (stages). A cell for folding sequentially passes through a plurality of folding process parts to be manufactured as a battery cell having a completely folded terrace.

The working positions of the plurality of folding process parts provided in the folding apparatus are arbitrarily set based on ’operator determination, which has made standardized management difficult. This made it difficult to track the history and changes in setting of working positions. Furthermore, when the size of the battery cell manufactured by the folding apparatus was changed, or when a folding process part was repaired and reinstalled, the working position of the folding process part should be re-set. In this process, there was difficulty in accurately setting the working position.

Since an operator arbitrarily set the working position directly using the actual cell for folding, a significant amount of time was required to set the working position of each of the plurality of folding process parts.

Furthermore, when the folding apparatuses were installed on a plurality of production lines, variations occurred in the setting of working positions for each production line. This resulted in significant variations in the quality of the folded portions formed on the battery cells.

According to an aspect of the present disclosure, a manufacturing apparatus of a battery cell, a manufacturing method of a battery cell, and a master block for standardizing the setting of a working position of each of a plurality of folding process parts may be provided.

According to an aspect of the present disclosure, a manufacturing apparatus of a battery cell, a manufacturing method of a battery cell, and a master block for standardizing a setting operation of the working position of a plurality of folding process parts in a plurality of production lines may be provided. Accordingly, even when the folding apparatus is installed on each of the plurality of production line, variations in setting the working positions for each production line may be reduced or minimized.

According to an aspect of the present disclosure, a manufacturing apparatus of a battery cell, a manufacturing method of a battery cell, and a master block capable of shortening a time required to set the working positions for each of the plurality of folding process parts may be provided.

According to an aspect of the present disclosure, a manufacturing apparatus of a battery cell, a manufacturing method of a battery cell, and a master block capable of maintaining consistent quality of a folded portion formed in a battery cell may be provided.

According to an aspect of the present disclosure, a manufacturing apparatus of a battery cell, a manufacturing method of a battery cell, and a master block capable of easily identifying a cause of an abnormality through comparison between production lines when the abnormality occurs in a folding process may be provided.

The battery cells manufactured by the manufacturing apparatus of a battery cell and the manufacturing method of a battery cell of the present disclosure may be widely applied to devices within green technology fields such as electric vehicles, battery charging stations, and other battery-based solar power generation and wind power generation devices. Furthermore, the battery cells manufactured by the manufacturing apparatus of a battery cell and the manufacturing method of a battery cell of the present disclosure may be used in eco-friendly electric vehicles, hybrid vehicles, and other vehicles that ameliorate the effects of climate change by suppressing air pollution and greenhouse gas emissions.

In some embodiments of the present disclosure, a manufacturing apparatus of a battery cell includes: a cell transfer part including a carrier provided so that a cell for folding is mounted on the carrier; a folding apparatus including a plurality of folding process parts for folding a terrace of the cell for folding transferred by the cell transfer part; a master block mounted on the carrier and structured to adjust a reference origin of each of the plurality of folding process parts; a storage part storing a working position of each of the plurality of folding process parts; and a controller controlling driving of the cell transfer part and the plurality of folding process parts to process the terrace of the cell for folding, with positions of the plurality of folding process parts set to a respective working positions stored in the storage part, in which the working position of each folding process part stored in the storage part may be set by the reference origin of each folding process part and a preset offset value for each folding process part, and the reference origin of each folding process part may be set by moving each folding process part toward the master block mounted on the carrier and bringing each folding process part into contact with the master block.

The master block may include a body having a first reference surface on a side surface and an extension portion extending from the first reference surface of the body in a first direction.

The reference origin of each folding process part in the first direction may be set to a position in which each folding process part moves toward the first reference surface and the outer side surface of each folding process part contacts the first reference surface.

The working position of each folding process part stored in the storage part may be set to a value obtained by adding the reference origin of each folding process part to the preset offset value for each folding process part.

The working position of each folding process part in the first direction may be set by considering a distance between the first reference surface and a work reference line where the terrace is processed, and the preset offset value for each folding process part may be set to a value obtained by subtracting the distance between a position of the outer side surface and the work reference line of each folding process part from the distance between the first reference surface and the work reference line.

The master block may have a second reference surface in a second direction, perpendicular to the first direction, on a lower surface or an upper surface of the extension portion.

The extension portion may extend from the body at a position spaced apart from a lower surface of the body by a first height, and the first height may have a value less than a thickness of the body.

The extension portion may extend to both sides of the body in the first direction, respectively.

The master block may include a fastening part that is fastened to the carrier, and the fastening part may include at least two slot-shaped holes.

Each folding process part may include a position adjusting part that adjusts a position in a first direction approaching the master block and a position in a second direction corresponding to a height direction of the master block.

The plurality of folding process parts may include at least one of a cell alignment part that aligns the cell for folding, a cutting part that cuts the terrace of the cell for folding to a preset length, a pre-folding line forming part forming a folding guide line on the terrace of the cell for folding, a first folding part that folds the terrace of the cell for folding at a first angle, a first pressing part that presses the folded portion folded at the first angle, a second folding part that folds the terrace of the cell for folding at a second angle, a second pressing part that presses a folded portion folded at the second angle, and a sizing part that reduces an external size of the folded portion folded at the second angle.

In some embodiments of the present disclosure, a manufacturing method of a battery cell includes: installing a master block on a carrier of a cell transfer part that transfers a cell for folding; setting a reference origin for each of a plurality of folding process parts; setting working positions for each of the plurality of folding process parts; storing the working positions of each of the plurality of folding process parts; and controlling driving of each of the plurality of folding process parts at each working position stored in the storing of the working position to form a folded portion in the cell for folding, in which the setting of the reference origin may include moving each folding process part toward the master block mounted on the carrier to bringing each folding process part into contact with the master block.

The master block may include a body having a first reference surface on a side surface and an extension portion extending from the first reference surface of the body in a first direction, in the setting of the reference origin, each folding process part may move toward the first reference surface in the first direction and a position where an outer side surface of each folding process part contacts the first reference surface is set as the reference origin of each folding process part.

In the setting of the working position, a value obtained by adding the reference origin of each folding process part and a preset offset value for each folding process part may be set to the working position of each folding process part.

In the installing of the master block, the first reference surface may be aligned to be perpendicular to the first direction using at least two slot-shaped holes provided in the master block.

The setting of the working position may include adjusting the position of each folding process part in a first direction in which each folding process part approaches the master block and adjusting the position of each folding process part in a second direction which is a height direction of the master block.

In some embodiments of the present disclosure, a master block mounted on a carrier that transfers a cell for folding to set a working position of a folding process part that folds a terrace of the cell for folding includes: a body having a first reference surface on a side surface of the body; and an extension portion extending from the first reference surface of the body in a first direction, in which the extension portion may have a second reference surface on a lower surface or an upper surface in a second direction, perpendicular to the first direction,.

### BRIEF DESCRIPTION OF DRAWINGS

Certain aspects, features, and advantages of the present disclosure are illustrated by the following detailed description with reference to the accompanying drawings.

FIG. 1 is a plan view of a cell for folding according to one embodiment.

FIG. 2 is a cross-sectional view taken along line I-I’ of FIG. 1.

FIGS. 3A - 3F are explanatory views sequentially illustrating examples of a change in shape of a terrace of a cell for folding along line I-I’ of FIG. 1 during folding of the terrace of the cell for folding illustrated in FIG. 1.

FIG. 4 is a perspective view illustrating a shape of a folded battery cell.

FIG. 5 is a schematic diagram of a manufacturing apparatus of a battery cell according to one embodiment.

FIG. 6 is a perspective view schematically illustrating the manufacturing apparatus of a battery cell according to one embodiment.

FIGS. 7A - 7C are plan views illustrating a process of setting a working position of a folding process part in the manufacturing apparatus of a battery cell according to one embodiment.

FIG. 8 is a side view for describing the process for setting the working position of the folding process part in the manufacturing apparatus of a battery cell according to one embodiment.

FIG. 9 is a perspective view illustrating a master block illustrated in FIG. 8.

FIG. 10 is a side view illustrating a modified example of a carrier illustrated in FIG. 8.

FIG. 11 is a plan view illustrating the carrier and the master block illustrated in FIG. 10.

FIG. 12 is a schematic diagram illustrating work reference lines performed in each folding process part.

FIG. 13 is a side view for describing a working position of a pre-folding line forming part for the cell for folding.

FIG. 14 is a side view for describing a working position of a first folding part for the cell for folding.

FIG. 15 is a schematic diagram illustrating the correspondence between a reference line for the cell for folding and a first reference surface of the master block.

FIG. 16 is a flowchart illustrating a manufacturing method of a battery cell according to one embodiment.

### DETAILED DESCRIPTION

Hereinafter, the present disclosure will be described in detail with reference to the accompanying drawings. However, this is merely an example and the present disclosure is not limited to specific embodiments described herein by way of example.

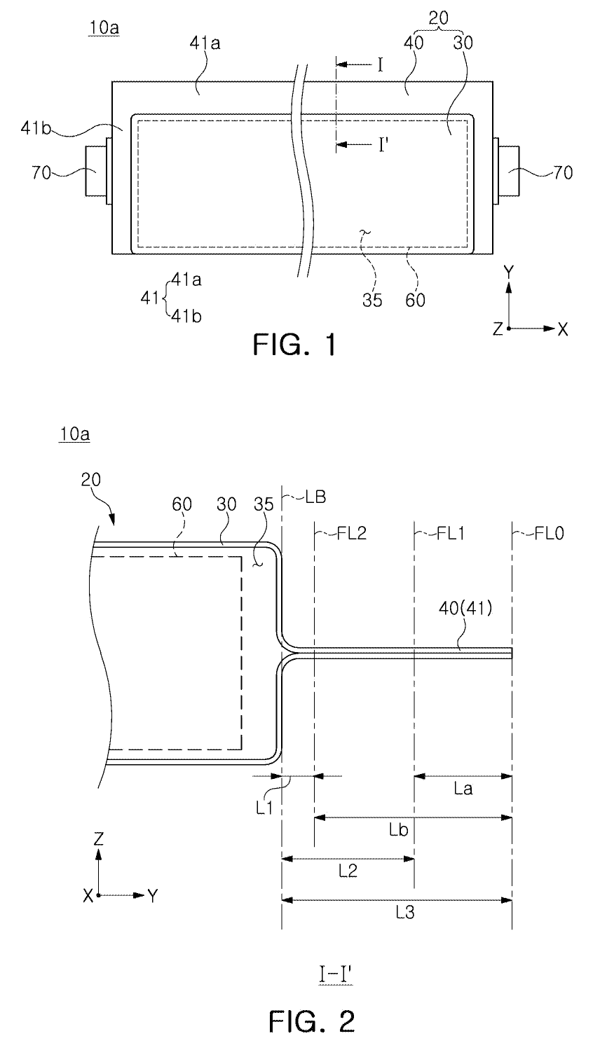

FIG. 1 is a plan view of a cell 10a for folding according to one embodiment. FIG. 2 is a cross-sectional view taken along line I-I’ of FIG. 1.

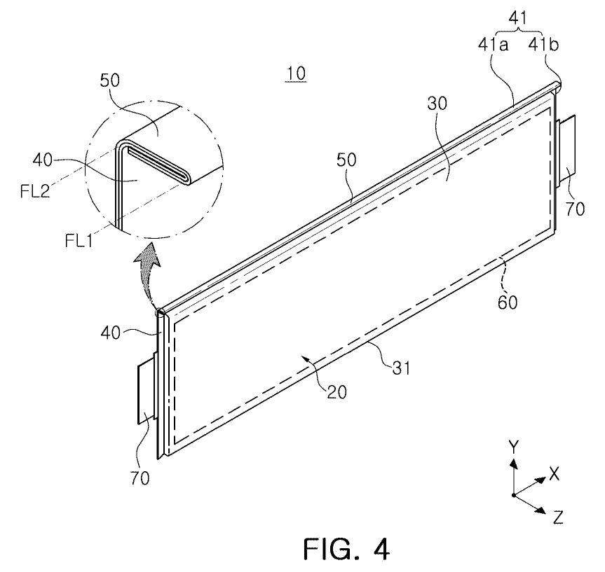

FIGS. 1 and 2 illustrate the cell 10a for folding prior to folding, and a battery cell 10 (FIG. 4) of the present disclosure may be formed by folding a terrace 40 of the cell 10a for folding.

Referring to FIGS. 1 and 2, the cell 10a for folding may include a cell case 20 and an electrode assembly 60 accommodated within the cell case 20. The electrode lead 70 connected to the electrode assembly 60 may be exposed to the outside of the cell case 20. The electrode assembly 60 may include a cathode plate, an anode plate, and a separator. The separator may be disposed between the cathode plate and the anode plate.

The cell case 20 may include an electrode accommodating portion 30 forming an accommodating space 35 for accommodating the electrode assembly 60, and the terrace 40 that is disposed on at least a portion of a periphery of the electrode accommodating portion 30 and extends outward from the electrode accommodating portion 30. The cell case 20 may include a pouch film.

At least a portion of the terrace 40 may be heat-sealed to form a sealing portion 41. The sealing portion 41 may be formed on an edge of the terrace 40 or a portion adjacent to the edge. The sealing portion 41 may protect the electrode assembly 60 from the outside by heat-sealing a contacting surface of the cell case 20.

The sealing portion 41 may include a first sealing portion 41a positioned on a peripheral surface of the electrode accommodating portion 30 where the electrode lead 70 is not disposed, and a second sealing portion 41b positioned on a surface where the electrode lead 70 is disposed. When the cell case 20 is formed from a single pouch film, the electrode accommodating portion 30 may be formed by folding the single pouch film. In this case, the electrode accommodating portion 30 may have a shape in which among four surfaces of the electrode accommodating portion 30, three surfaces are open and one surface (31 of FIG. 4) is closed. The sealing portion 41 may be formed on the three open surfaces of the electrode accommodating portion 30.

FIG. 2 illustrates a cross-section of a portion of the terrace 40 where the electrode lead 70 is not disposed. The terrace 40 of the cell 10a for folding may extend outside the electrode accommodating portion 30 by a preset length. After the sealing portion 41 is formed on the terrace 40, the terrace 40 may be cut to a preset length. An end line FL0 may be defined as a line passing through an end of the terrace 40 in a state in which the terrace 40 is cut to a preset length during the initial folding process.

The terrace 40 may be folded based on a first folding line FL1 and a second folding line FL2. The first folding line FL1 may be set at a position spaced apart from the end line FL0 of the terrace 40 by a preset length La. The second folding line FL2 may be set at a position spaced apart from the end line FL0 of the terrace 40 by a preset length Lb.

A reference line LB of the cell 10a for folding may be positioned at a boundary area between the electrode accommodating portion 30 and the terrace 40. The reference line LB of the cell 10a for folding may extend along a longitudinal direction (X-axis direction) of the electrode accommodating portion to form a reference surface on an X-Z plane. The reference line LB may be defined as a line that is perpendicular to the direction in which the terrace 40 extends (Y-axis direction) and passes through a side surface of the electrode accommodating portion 30. At least a portion of the side surface of the electrode accommodating portion 30 may include a surface perpendicular to the terrace 40, and the reference line LB may face in a direction (Z-axis direction) perpendicular to the terrace 40. However, the definition of the reference line LB is not limited thereto, and may be defined in various ways at the boundary area between the electrode accommodating portion 30 and the terrace 40 as long as the reference line LB is a straight line perpendicular to the direction (Y-axis direction) in which the terrace 40 extends.

The second folding line FL2 may be set at a position spaced apart from the reference line LB by a first length L1, the first folding line FL1 may be set at a position spaced apart from the reference line LB by the first length L1, and the end line FL0 may be set at a position spaced apart from the reference line LB of the electrode accommodating portion 30 by a third length L3. The first length L1, the second length L2, and the third length L3 may have preset values depending on the design specifications of the cell 10a for folding or the battery cell 10 (FIG. 4).

Meanwhile, the cell 10a for folding and the battery cell 10 (FIG. 4) according to one embodiment are not limited to a structure in which the sealing portion 41 is formed on three surfaces of the electrode accommodating portion 30. For example, the cell 10a for folding and the battery cell 10 (FIG. 4) may be formed by overlapping two pouch films and then forming the cell case 20 in which the electrode accommodating portion 30 is formed. In this case, the sealing portion 41 may be formed on all four surfaces of the electrode accommodating portion 30.

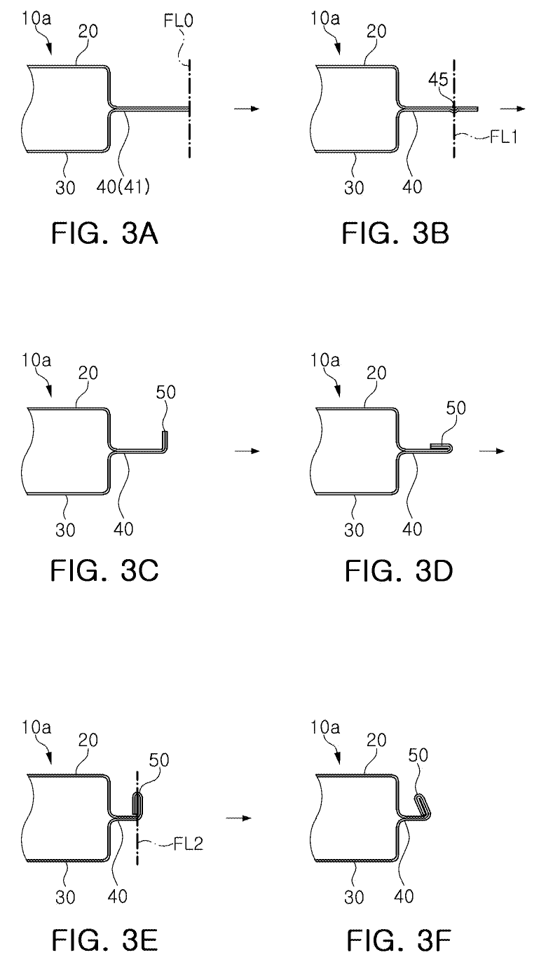

FIGS. 3A - 3F are explanatory views sequentially illustrating examples of a change in shape of the terrace 40 of the cell 10a for folding along line I-I’ of FIG. 1 during folding of the terrace 40 of the cell 10a for folding illustrated in FIG. 1. FIGS. 3A - 3F each are cross-sectional views taken along line I-I’ of FIG. 1, with the electrode assembly 60 (FIG. 2) omitted.

Referring toFIGS. 3A - 3F together with FIGS. 1 and 2, the terrace 40 of the cell 10a for folding may be folded to increase the bonding reliability of the sealed sealing portion 41 and reduce the volume occupied by the terrace 40.

FIG. 3A illustrates a state in which the sealing portion 41 is formed on the terrace 40 through sealing processing and then cut along the end line FL0. The terrace 40 of the battery cell 10 may have an angle of 0° before folding, i.e., in the unfolded state.

FIG. 3B illustrates a state in which a folding guide line (pre-folding line) 45 is formed on the terrace 40 of the cell 10a for folding. The folding guide line 45 may be formed on a first folding line FL1 spaced apart from the electrode accommodating portion 30 by a predetermined distance. The folding guide line 45 may be formed along the longitudinal direction of the terrace 40. The folding guide line 45 may have a groove shape.

FIGS. 3C - 3F illustrate an example of the folding process. The terrace 40 may form a folded part 50 folded at a specific angle after undergoing at least one folding process.

FIGS. 3C and 3D illustrate the folded portion 50 in which the terrace 40 is folded based on a folding guide line (pre-folding line) 45 through a first folding process. The first folding process may be a process of folding the terrace 40 at a specific angle (for example, approximately 180°). When the folding guide line 45 having a groove shape is formed in advance on the terrace 40, the folding portion 50 may be easily formed by the folding guide line 45. The first folding process may fold the terrace 40 at approximately 180° through one or more processes. For example, the terrace 40 may be primarily folded at approximately 90° as illustrated in FIG. 3C, and then secondarily folded as illustrated in FIG. 3D. However, the number of part processes constituting the first folding process may be changed. For example, the first folding process may fold the terrace 40 approximately 180° in a single process. After the first folding process, a first pressing process may be performed in which the folded portion 50 is pressed so that the folding portion 50 maintains its folded state.

FIG. 3E illustrates a second folding process that additionally folds the terrace 40. Through the second folding process, the folding portion 50 may have a shape folded approximately 270°.

FIG. 3F illustrates a state in which a sizing process is performed to press the folding portion 50 toward the electrode accommodating portion 30 to prevent the folding portion 50 folded at 270° from unfolding due to a springback phenomenon after the secondary folding process.

FIGS. 3A - 3F illustrate an example of the folding process. The number of processes constituting the folding process, the folding angle of the folded portion 50 formed through each folding process, etc., may be variously changed.

FIG. 4 is a perspective view illustrating the battery cell 10 according to one embodiment. FIG. 4 illustrates the folded battery cell 10.

Referring to FIG. 4, the battery cell 10 may include the cell case 20 and the electrode assembly 60 accommodated inside the cell case 20. The cell case 20 may include the electrode accommodating portion 30 that accommodates the electrode assembly 60, and the terrace 40 disposed around at least a portion of the electrode accommodating portion 30. The terrace 40 may extend outward from the electrode accommodating portion 30.

At least a portion of the terrace 40 may be heat-sealed to form the sealing portion 41. The sealing portion 41 may be formed on three surfaces of the periphery of the electrode accommodating portion 30 of the terrace 40, excluding a bottom surface 31 of the electrode accommodating portion 30. The sealing portion 41 may include a first sealing portion 41a positioned on a peripheral surface of the electrode accommodating portion 30 where the electrode lead 70 is not disposed, and a second sealing portion 41b positioned on a surface where the electrode lead 70 is disposed. The first sealing portion 41a may be folded based on the first folding line FL1 and then additionally folded based on the second folding line FL2. In FIG. 4, the folded portion 50 is illustrated as having a folded shape of approximately 270°. However, the folded portion 50 may be folded at an angle greater than 270°. To prevent the folded portion 50 from easily unfolding due to the springback phenomenon, the folded portion 50 may be attached to the electrode accommodating portion 30 using tape.

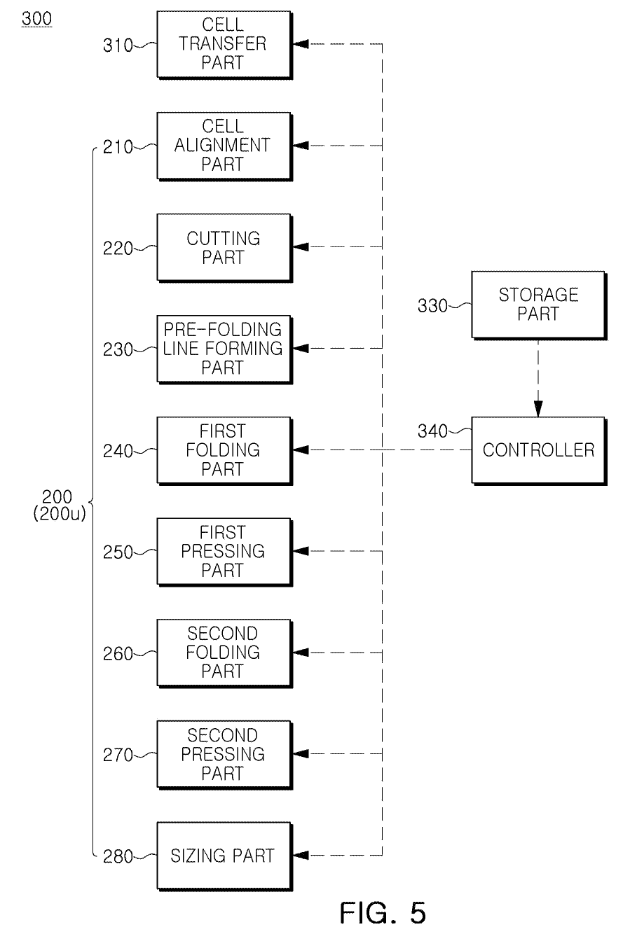

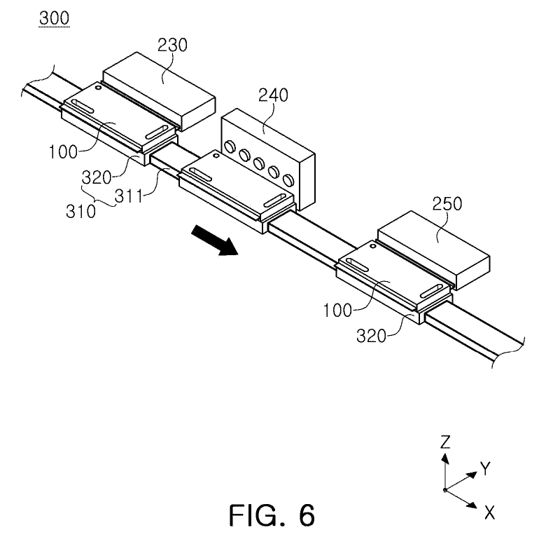

FIG. 5 is a schematic diagram of a manufacturing apparatus 300 of a battery cell according to one embodiment. FIG. 6 is a perspective view schematically illustrating the manufacturing apparatus 300 of a battery cell according to one embodiment. For convenience of illustration, FIG. 6 schematically illustrates a pre-folding line forming part 230, a first folding portion 240, and a first pressing portion 250 among a plurality of folding process parts 200u.

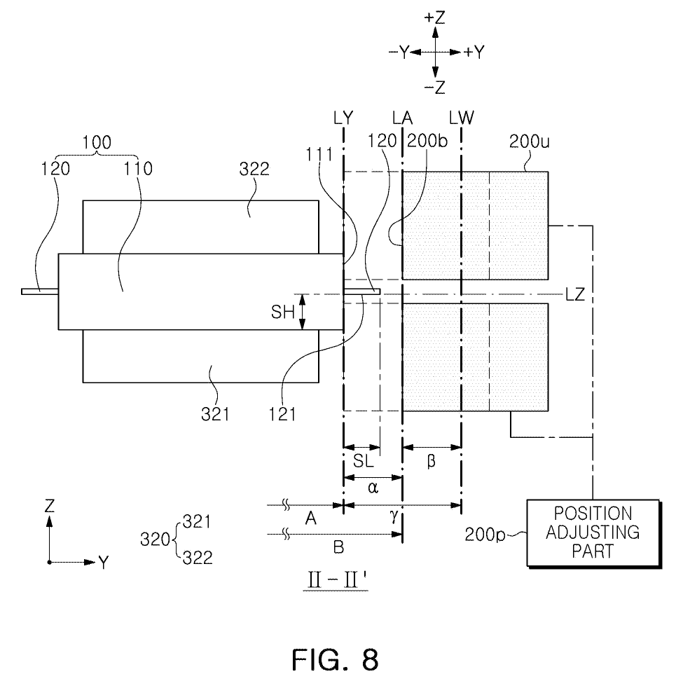

Referring to FIGS. 5 and 6 together withFIGS. 3A - 3F, the manufacturing apparatus 300 of a battery cell according to one embodiment may include a cell transfer part 310 including a carrier 320 provided so that the cell 10a for folding may be mounted on the carrier 320, a folding apparatus 200 including the plurality of folding process parts 200u for folding the terrace 40 of the cell 10a for folding transferred by the cell transfer part 310, a master block 100 mounted on the carrier 320 and used for adjusting a reference origin A (FIG. 8) of each of the plurality of folding process parts 200u, a storage part 330 storing a working position B (FIG. 8) of each of the plurality of folding process parts 200u, and a controller 340 that controls driving of the cell transfer part 310 and the plurality of folding process parts 200u to process the terrace 40 of the cell 10a for folding in a state in which the positions of the folding process parts 200u are set to a respective working positions B stored in the storage part 300.

The cell transfer part 310 may include the carrier 320 on which the cell 10a for folding may be mounted. The cell transfer part 310 may include a transfer guide 311 to guide the movement of the carrier 320. For example, the transfer guide 311 may include a guide rail. The carrier 320 is transferred in an X-axis direction along the transfer guide 311, thereby providing the cell 10a for folding to each of the plurality of folding process parts 200u.

Since the cell 10a for folding is fixed to the carrier 320, the cell 10a for folding may remain fixed when work is performed in the folding process part 200u. The carrier 320 may move along the transfer guide 311 while supporting the cell 10a for folding. As an example, the carrier 320 may include a linear motor stage LMS or a linear transfer. The linear motor stage may have a structure that supports the upper and lower portions of the cell 10a for folding by applying pressure. The linear transfer may fix the cell 10a for folding through a vacuum suction method. The linear transfer may have a structure that suctions the cell 10a for folding from the lower portion of the cell 10a for folding. However, the shape or structure of the carrier 320 is not limited to the above-described example and may be variously changed.

Referring to FIGS. 5 and 6 together with FIGS. 3A - 3F, the folding apparatus 200 may include the plurality of folding process parts 200u for folding the terrace 40 of the cell 10a for folding transferred by the cell transfer part 310.

As an example, the plurality of folding process parts 200u may include at least some of an alignment part that aligns the cell 10a for folding, a cutting part that cuts the terrace 40 of the cell 10a for folding to a length suitable for forming the folded portion 50, a folding part that folds the terrace 40 of the cell 10a for folding at a preset angle to form the folded portion 50, a pressing part that presses the folded portion 50 to maintain the folded angle, and a sizing part that presses the folded portion 50 toward the electrode accommodating portion to reduce the size of the folded portion 50.

Describing in detail, the plurality of folding process parts 200u may include at least a portion of a cell alignment part 210 that aligns the cell 10a for folding, a cutting part 220 that cuts the terrace 40 of the cell 10a for folding to a preset length, a pre-folding line forming part 230 forming the folding guide line 45 on the terrace 40 of the cell 10a for folding, a first folding part 240 that folds the terrace 40 of the cell 10a for folding at a first angle, a first pressing part 250 that presses the folded portion 50 folded at the first angle, a second folding part 260 that folds the terrace 40 of the cell 10a for folding at a second angle, a second pressing part 270 that presses the folded portion 50 folded at the second angle, and a sizing part 280 that reduces an external size of the folded portion 50 folded at the second angle.

The cell alignment part 210 may align the cell 10a for folding to a preset position. For example, the cell alignment part 210 may adjust the position of the cell 10a for folding so that multiple corners or edges of the cell 10a for folding have a preset position.

The cutting part 220 may form the sealing portion 41 on the terrace 40 through sealing processing, and then, cut the terrace 40 of the cell 10a for folding to a length suitable for forming the folded portion 50 in a state in which the sealing is complete. FIG. 3A illustrates the terrace 40 cut by the cutting part 220.

The pre-folding line forming part 230 may form a pre-folding line (folding guide line) 45 on the terrace 40 of the cell 10a for folding. Referring to FIG. 3B, the folding guide line 45 may be formed in a groove shape on the first folding line FL1 spaced apart from the electrode accommodating portion 30 by a predetermined distance.

The first folding portion 240 may fold the terrace 40 of the cell 10a for folding at a first angle. For example, the first folding portion 240 may fold the terrace 40 so that the folded portion 50 has a shape folded at 180°. FIGS. 3C and 3D each illustrate the folded portion 50 in which the terrace 40 is folded at a predetermined angle with respect to the folding guide line 45 through the first folding portion 240. The first folding portion 240 may include a plurality of parts. For example, the first folding part 240 may include at least one part that processes the folded portion 50 so that it is folded at approximately 90°, and at least one part that processes the folded portion 50 so that it is folded at approximately 180°. For example, the first folding part 240 may include a plurality of rollers that sequentially increase the folded angle of the terrace 40. Alternatively, the first folding part 240 may include a mold in which grooves sequentially increasing the folded angle of the folded portion 50 are formed. However, the structure or shape of the first folding part 240 may be variously changed.

The first pressing part 250 may press the folded portion 50 folded at the first angle by the first folding part 240 so that the folded portion 50 maintains the state in which it is folded at the first angle. The first pressing part 250 may press the folded portion 50 folded at a first angle in the vertical direction (Z-axis direction). The first pressing part 250 may include a pressing jig.

The second folding portion 260 may fold the terrace 40 of the cell 10a for folding at a second angle. The second folding part 260 may additionally fold the folded portion 50 folded at the first angle so that the folded portion 50 has the second angle. As an example, the second folding part 260 may fold the folded portion 50 so that it has a shape folded at approximately 270°. FIG. 3E illustrates the folded portion 50 folded at the second angle by the second folding part 260. The second folding portion 260 may include a plurality of parts. For example, the second folding part 260 may include at least one part that processes the folded portion 50 into a state in which it is folded at the second angle. For example, the second folding part 260 may include a plurality of rollers that sequentially increase the folded angle of the terrace 40. However, the structure or shape of the second folding part 260 may be variously changed.

The second pressing part 270 may press the folded portion 50 folded at the second angle by the second folding part 260 so that the folded portion 50 maintains the state in which it is folded at the second angle. The second pressing part 270 may press the folded portion 50 folded at the second angle in the direction (Y-axis direction) in which the folded portion 50 is folded.

The sizing part 280 may press the folded portion 50 toward the electrode accommodating portion 30 to prevent the folded portion 50 folded at the second angle from unfolding due to the springback phenomenon. FIG. 3F illustrates a state in which the folded portion 50 is pressed toward the electrode accommodating portion 30 by the sizing part 280. The folded portion 50 may have a third angle greater than 270° by the sizing part 280.

However, the configuration of the plurality of folding process parts 200u described above is merely an example, and the number, structure, and arrangement of the folding process parts 200u provided to the folding apparatus 200 may be changed.

The master block 100 may be used to adjust the reference origin A (FIG. 8) of each of the plurality of folding process parts 200u. The master block 100 may be mounted on the carrier 320 that transfers the cell 10a for folding to set the working position B (FIG. 8) of the folding process part 200u that folds the terrace 40 of the cell 10a for folding.

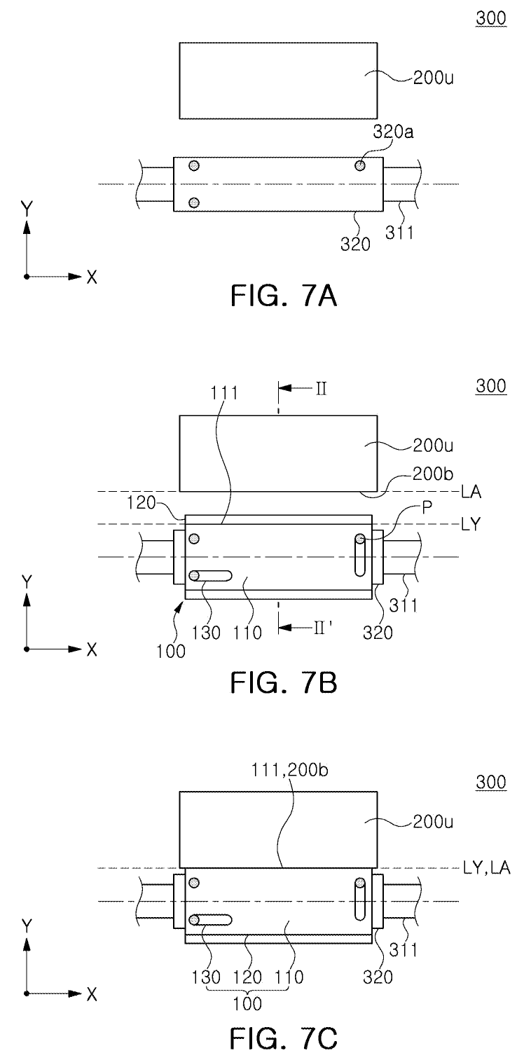

The master block 100 may be mounted on the carrier 320 instead of the cell 10a for folding during the process of setting the reference origin A (FIG. 8) of each of the plurality of folding process parts 200u. The master block 100 may be fixed to the carrier 320 while being aligned to have a preset position. To set the reference origin A for each of the plurality of folding process parts 200u, the master block 100 may move to a position facing each folding process part 200u by the cell transfer part 310. A detailed description of the master block 100 will be described later with reference to FIGS. 7 - 11.

The storage part 330 may store the working position B (FIG. 8) of each of the plurality of folding process parts 200u. The storage part 330 may include a memory for storing the working position B.

The controller 340 may control the driving of the cell transfer part 310 and the plurality of folding process parts 200u to process the terraces 40 of the cell 10a for folding in the state in which the positions of the plurality of folding process parts 200u are set to the respective working positions B (FIG. 8) stored in the storage part 330.

The working position B (FIG. 8) of each of the plurality of folding process parts 200u may be set to each working position B stored in the storage part 330. The controller 340 may control the driving of the cell transfer part 310 so that the cell 10a for folding mounted on the carrier 320 of the cell transfer part 310 is transferred to each folding process part 200u in the state in which the positions of the plurality of folding process parts 200u are adjusted to the working position B. The controller 340 may control the driving of the folding process part 200u so that the terrace 40 of the cell 10a for folding transferred to each folding process part 200u is processed.

In some folding process parts 200u, the controller 340 may process the terrace 40 of the cell 10a for folding while transporting the cell 10a for folding in the state in which the position of the folding process part 200u is fixed. For example, when processing the terrace 40 through the first folding part 240, the second folding part 260, and the sizing part 280, the controller 340 may transfer the cell 10a for folding in the state in which the position of the folding process part 200u is fixed.

In some folding process parts 200u, the controller 340 may process the terrace 40 of the cell 10a for folding by driving the folding process part 200u in the state in which the position of the cell 10a for folding is fixed. For example, when processing the terrace 40 using the cell alignment part 210, the cutting part 220, the pre-folding line forming part 230, the first pressing part 250, and the second pressing part 270, the controller 340 may operate the folding process part 200u in the state in which the position of the cell 10a for folding is fixed.

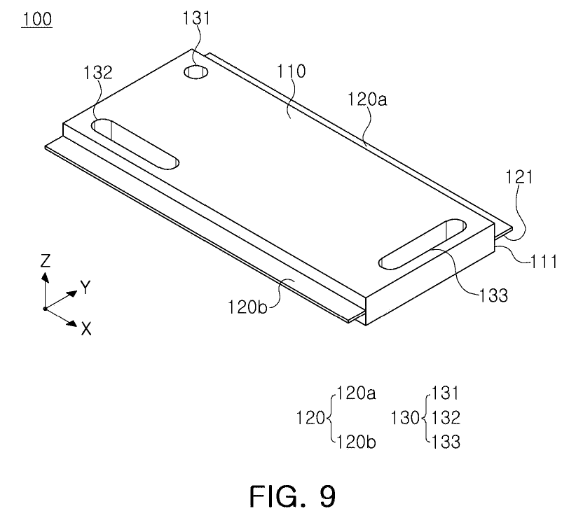

FIGS. 7A - 7C are plan views illustrating the process of setting the working position B (FIG. 8) of the folding process part 200u in the manufacturing apparatus 300 of a battery cell according to one embodiment. FIG. 8 is a side view illustrating the process of setting the working position B of the folding process part 200u in the manufacturing apparatus 300 of a battery cell according to one embodiment. FIG. 9 is a perspective view illustrating the master block 100 illustrated in FIG. 8.

Hereinafter, the process of setting the working position B of the folding process part 200u and the master block 100 will be described with reference to FIGS. 3A - 3F together with FIGS. 5 - 9.

As illustrated in FIG. 7A, the carrier 320 may be disposed on the transfer guide 311. The carrier 320 may be guided by the transfer guide 311 to move in the X-axis direction. The carrier 320 may include a mounting opening 320a. The mounting opening 320a may be formed as a groove or a hole. The mounting opening 320a may be used to fix the position of the master block 100.

As illustrated in FIG. 7B, the master block 100 may be mounted on the carrier 320 that transfers the cell 10a for folding to set the working position B of the folding process part 200u that folds the terrace 40 of the cell 10a for folding. The master block 100 may be installed on the carrier 320 instead of the cell 10a for folding and used to set the working position B of the folding process part 200u.

The master block 100 may include a fastening part 130 that is fastened to the carrier 320. The fastening part 130 of the master block 100 may include multiple holes that penetrate through the upper and lower portions of the master block 100. A position fixing member P may be inserted into the fastening part 130 of the master block 100. The position fixing member P may be inserted into the fastening part 130 of the master block 100 and the mounting opening 320a of the carrier 320 to align the master block 100 to a preset position on the carrier 320. Various members such as pins and bolts may be used as the position fixing member P.

Referring to FIG. 8, the carrier 320 may include a first carrier 321 that supports the lower portion of the master block 100 and a second carrier 322 that supports the upper portion of the master block 100. The first carrier 321 and the second carrier 322 may fix the cell 10a for folding so that it does not move during the folding process. The master block 100 may be fixed between the first carrier 321 and the second carrier 322 instead of the cell 10a for folding. The first carrier 321 moving on the transfer guide 311 may include the linear motor stage LMS.

The master block 100 will be described with reference to FIGS. 2 and 3A through 3F, 7B, 8 and 9.

The master block 100 may include a body 110 having a first reference surface 111 on a side surface of the body 110, and an extension portion 120 extending in a first direction (Y-axis direction) from the first reference surface 111 of the body 110. The body 110 of the master block 100 may have a shape corresponding to the electrode accommodating portion 30 of the cell 10a for folding. For example, the body 110 may have a rectangular parallelepiped shape. The extension portion 120 of the master block 100 may correspond to the terrace 40 of the cell 10a for folding.

Among the side surfaces of the master block 100, the surface facing the folding process part 200u may form the first reference surface 111. As an example, the first reference surface 111 may correspond to a reference line LB (FIG. 2) positioned at the boundary between the electrode accommodating portion 30 and the terrace 40 in the cell 10a for folding, but is not limited thereto. The first reference surface 111 may be used to set the working position B of the folding process part 200u in the first direction (Y-axis direction).

The extension portion 120 of the master block 100 may have a second reference surface 121 on a lower surface or an upper surface in a second direction (Z-axis direction), perpendicular to the first direction (Y-axis direction). For example, the lower surface of the extension portion 120 may form the second reference surface 121. A position LZ of the second reference surface 121 may be used to set the working position of the folding process part 200u in the second direction (Z-axis direction).

The extension portion 120 extends from the body 110 at a position spaced apart from the lower surface of the body 110 by a first height SH, and the first height SH may have a value smaller than a thickness of the body 110. The extension portion 120 may correspond to a position where the terrace 40 extends from the electrode accommodating portion 30 of the cell 10a for folding. Typically, the terrace 40 extends at a height spaced apart from the lower surface of the electrode accommodating portion 30, so the extension portion 120 of the master block 100 may also extend from the body 110 at a position spaced apart from the lower surface of the body 110 by the first height SH.

For example, the extension portion 120 may extend in the first direction (Y-axis direction) from the central region of the body 110 or a location adjacent thereto. The extension portion 120 of the master block 100 may extend by a first length SL corresponding to the terrace 40 of the cell 10a for folding.

The extension portion 120 may extend to each of both sides of the body 110 in the first direction (Y-axis direction). For example, the extension portion 120 may include a first extension portion 120a extending from a first side of the body 110 and a second extension portion 120b extending from a second side of the body 110.

As illustrated in FIG. 1, the cell 10a for folding may have a shape (three-sided sealing structure) extending from three surfaces of the electrode accommodating portion 30, but may also have a shape (four-sided sealing structure) extending from four surfaces of the electrode accommodating portion 30. For example, when the cell case 20 is formed of two pouch films, the sealing portion 41 may be formed around the four surfaces of the electrode accommodating portion 30. In this case, it is also possible for the folded portion 50 to be formed on the terraces 40 on both sides of the electrode accommodating portion 30 in the first direction (Y-axis direction). When forming the folded portion 50 on the two-sided terraces 40 of the cell 10a for folding having the four-sided sealing structure, the master block 100, in which the extension portion 120 extends from both sides of the body 110, may be used to set the working position of the folding process part 200u.

Meanwhile, the two-sided extension portion 120 may be set to different first heights SH from the lower surface of the body 110. In this case, the master block 100 may be used to set the reference origin A when manufacturing the cells 10a for folding having various sizes.

The master block 100 may include the fastening part 130 fastened to the carrier 320. The fastening part 130 may include at least two slot-shaped holes. The slot-shaped holes may be elongated holes extending in a specific direction. As an example, the fastening part 130 of the master block 100 includes a first fastening part 131, a second fastening part 132, and a third fastening part 133. The first fastening part 131 may be formed as a circular hole, and the second fastening part 132 and the third fastening part 133 may be formed as slot-shaped holes having a long length in a specific direction. The position fixing member P is first inserted into the first fastening part 131, and then the position of the master block 100 is adjusted. Thereafter, the position fixing members P are inserted into each of the second fastening part 132 and the third fastening part 133, thereby fixing the position of the master block 100.

When at least two slot-shaped holes are provided in the fastening part 130, the position of the master block 100 may be aligned on the X-Y plane when installing the master block 100 on the carrier 320. Accordingly, the first reference surface 111 of the master block 100 may be aligned to be positioned on the X-Z plane, and the second reference surface 121 may be aligned to be positioned on the X-Y plane.

For example, the extension direction of the second fastening part 132 and the extension direction of the third fastening part 133 may be orthogonal to each other. However, the number and/or positions of the fastening parts 130, and the extension direction and/or length of the slot-shaped holes may be variously changed.

The setting of the working position B of the folding process part 200u will be described with reference to FIGS. 7B through 8, together with FIGS. 2 and 3A through 3F.

The working position B of each folding process part 200u stored in the storage part 330 may be set by the reference origin A of each folding process part 200u and a preset offset value α for each folding process part 200u. The reference origin A of each folding process part 200u may be set by moving each folding process part 200u toward the master block 100 mounted on the carrier 320 and bringing each folding process part 200u into contact with the master block 100.

As illustrated in FIG. 7B, the folding process part 200u includes an outer side surface 200b facing the master block 100, and the body 110 of the master block 100 may include the first reference surface 111 facing the folding process part 200u. The outer side surface 200b of the folding process part 200u may have a position spaced apart from the first reference surface 111 of the master block 100. That is, a position LA of the outer side surface 200b of the folding process part 200u may be spaced apart from a position LY of the first reference surface 111.

The position LA of the outer side surface 200b of the folding process part 200u may be defined as the position of the portion where the folding process part 200u first contacts the first reference surface 111 as the folding process part 200u moves toward the first reference surface 111. That is, the position LA of the outer side surface 200b of the folding process part 200u may include a position of a point close to the first reference surface 111 at a portion where the folding process part 200u faces the first reference surface 111. For example, when the folding process part 200u includes a roller, the position LA of the outer side surface 200b of the folding process part 200u may correspond to the position of the portion of the outer side surface of the roller closest to the first reference surface 111. The position LY of the first reference surface 111 may be defined as a position on a plane passing through the first reference surface 111.

To set the reference origin A of each folding process part 200u, the folding process part 200u may be moved toward the master block 100 mounted on the carrier 320.

FIG. 7C illustrates a state in which the outer side surface 200b of the folding process part 200u and the first reference surface 111 are in contact. As illustrated in FIG. 7C, when the outer side surface 200b of the folding process part 200u and the first reference surface 111 are in contact, the position LA of the outer side surface 200b of the folding process part 200u may overlap with the position LY of the first reference surface 111.

Referring to FIG. 8, each folding process part 200u may include a position adjusting part 200p that adjusts the position in the first direction (Y-axis direction) approaching the master block 100 and the position in the second direction (Z-axis direction) that is a height direction of the master block 100. The position adjusting part 200p may move each folding process part 200u in a -Y-axis direction approaching the first reference surface 111 of the master block 100 or in a +Y-axis direction away from the first reference surface 111 of the master block 100. The position adjusting part 200p may move each folding process part 200u in a +Z-axis direction or a -Z-axis direction to approach the second reference surface 121 of the master block 100 or to move away from the second reference surface 121.

The position adjusting part 200p may be provided to adjust the working position B of the folding process part 200u. For example, the position adjusting part 200p of the folding process part 200u may include a servo motor. Since the servo motor may control a rotation angle, the rotation angle of the servo motor may be converted into a linear movement distance of the folding process part 200u. The movement distance of each folding process part 200u via the position adjusting part 200p may be provided to the storage part 330. However, the position adjusting part 200p is not limited to the servo motor, and various modifications are possible as long as the movement position of the folding process part 200u may be measured.

The folding process part 200u includes a pair of upper and lower mechanisms that cooperate with each other during the folding process, and the position adjusting part 200p may adjust the positions of the upper and lower pair of mechanisms.

In the first direction (Y-axis direction), the reference origin A of each folding process part 200u may be set to a position where the outer side surface 200b of each folding process part 200u comes into contact with the first reference surface 111 when each folding process part 200u moves toward the first reference surface 111. The reference origin A in the first direction (Y-axis direction) may include a Y-axis coordinate obtained when positioning the folding process part 200u through the position adjusting part 200p. For example, the reference origin A may include a Y-axis coordinate provided by the position adjusting part 200p in the state in which the outer side surface 200b of the folding process part 200u comes into contact with the first reference surface 111 of the master block 100.

In the second direction (Z-axis direction), the reference origin may be set to a position in which each folding process part 200u comes into contact with the second reference surface 121 when each folding process part 200u moves toward the second reference surface 121. The reference origin in the second direction (Z-axis direction) may include a Z-axis coordinate obtained when positioning the folding process part 200u through the position adjusting part 200p. For example, the reference origin in the second direction may include a Z-axis coordinate provided by the position adjusting part 200p when the folding process part 200u comes into contact with the second reference surface 121 of the master block 100.

The reference origin provided by the position adjusting part 200p obtained when each folding process part 200u is in contact with the first reference surface 111 and/or the second reference surface 121 of the master block 100 may be stored in the storage part 330 (FIG. 5).

A work reference line LW may be defined as a position on the X-Z plane where actual work is performed when processing the terrace 40 of the cell 10a for folding. For example, as illustrated in FIG. 2, the first folding line FL1 formed in the cell 10a for folding may be formed at a position spaced apart from the reference line LB by a second length L2. Accordingly, when a folding guideline (pre-folding line) 45 is formed on the terrace 40 of the cell 10a for folding as illustrated in FIG. 3B, the first folding line FL1 may correspond to the work reference line LW illustrated in FIG. 8. When the position LY of the first reference surface 111 corresponds to the reference line LB of the cell 10a for folding, the first folding line FL1 may correspond to the work reference line LW. That is, the position LY of the first reference surface 111 and the work reference line LW may have a value spaced apart by the second length L2. Accordingly, the relative position of the work reference line LW with respect to the position LY of the first reference surface 111 in each folding process part 200u may have a preset value.

The work reference line LW may coincide with the outer side surface 200b of the folding process part 200u, depending on the structure or shape of each folding process part 200u. Alternatively, the work reference line LW may be set at a position spaced apart from the outer side surface 200b of the folding process part 200u in the +Y direction. For example, as illustrated in FIG. 8, the work reference line LW of the folding process part 200u may be spaced apart from the position LA of the outer side surface 200b of the folding process part 200u in the +Y direction by a first relative distance β.

The second length L2 between the reference line LB of the cell 10a for folding and the first folding line FL1 may have a preset value. When the reference line LB of the cell 10a for folding corresponds to the position LY of the first reference surface 111, the first folding line FL1 may correspond to the work reference line LW. Therefore, the second relative distance γ between the position LY of the first reference surface 111 and the work reference line LW may have the same value as the second length L2.

The work reference line LW of the folding process part 200u may have a preset value spaced apart from the position LA of the outer side surface 200b of the folding process part 200u by the first relative distance β. Therefore, by moving the folding process part 200u in the +Y-axis direction from the reference origin A by a value obtained by subtracting the first relative distance β from the second relative distance γ, the working position B of the folding process part 200u may be set. The value obtained by subtracting the first relative distance β from the second relative distance γ may be defined as an offset value α. That is, when the outer side surface 200b of each folding process part 200u is moved relative to the +Y-axis direction by the offset value α from the reference origin A where it comes into contact with the first reference surface 111, the working position B of each folding process part 200u may be set. At the working position B of each folding process part 200u, the work reference line LW may coincide with the line (for example, the first folding line FL1) on which the processing of the terrace 40 is performed.

As described above, the working position B of each folding process part 200u may be set by the reference origin A of each folding process part 200u and the preset offset value α for each folding process part 200u. The offset value α may be preset according to the size and design specifications of the cell 10a for folding.

Furthermore, the working position B of each folding process part 200u stored in the storage part 330 may be set to a value obtained by adding the reference origin A of each folding process part 200u to the preset offset value α for each folding process part 200u. In other words, the working position B of the folding process part 200u may be set to a position where the folding process part 200u moves in the +Y-axis direction by the offset value α from the reference origin A. The working position B of each folding process part 200u stored in the storage part 330 may be a relative coordinate value provided by each position adjusting part 200p.

The working position B of each folding process part 200u in the first direction (Y-axis direction) may be set by considering the distance between the first reference surface 111 and the work reference line LW on which the processing of the terrace 40 is performed. That is, the working position B of the folding process part 200u may be set by considering the second relative distance γ between the position LY of the first reference surface 111 and the work reference line LW.

In the first direction (Y-axis direction), the preset offset value α for each folding process part 200u may be set to a value obtained by subtracting the distance between the position LA of the outer side surface 200b and the work reference line LW of each folding process part 200u from the distance between the first reference surface 111 and the work reference line LW. In other words, the offset value α may be set to a value obtained by subtracting the first relative distance β between the position LA of the outer side surface 200b of the folding process part 200u and the work reference line LW from the second relative distance γ between the position LY of the first reference surface 111 and the work reference line LW.

Meanwhile, in the second direction (Z-axis direction), the working position of each folding process part 200u may be set to a position in which each folding process part 200u comes into contact with the second reference surface 121.

Thus, according to one embodiment, the working position setting for each of the plurality of folding process parts 200u may be standardized, and the time required for setting the working position for each of the plurality of folding process parts 200u may be reduced. Furthermore, the quality of the folded portion 50 formed on the battery cell 10 may be maintained consistently. Furthermore, even when the folding apparatus 200 is installed on a plurality of production lines, variations in the working position setting for each production line may be reduced or minimized.

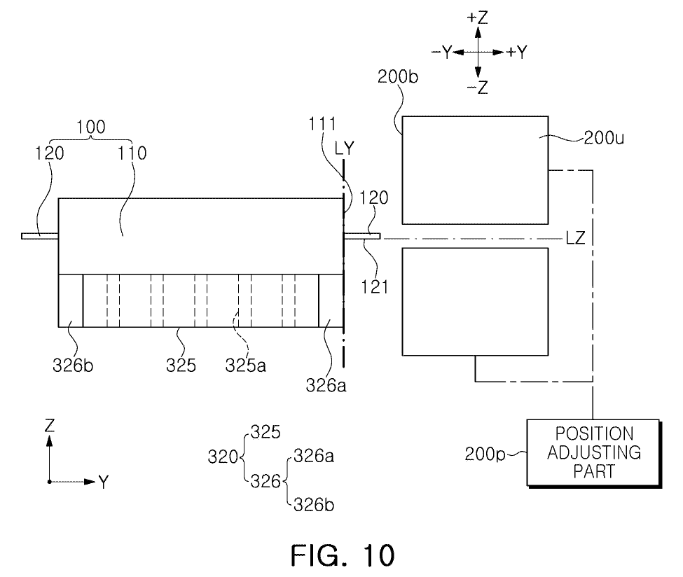

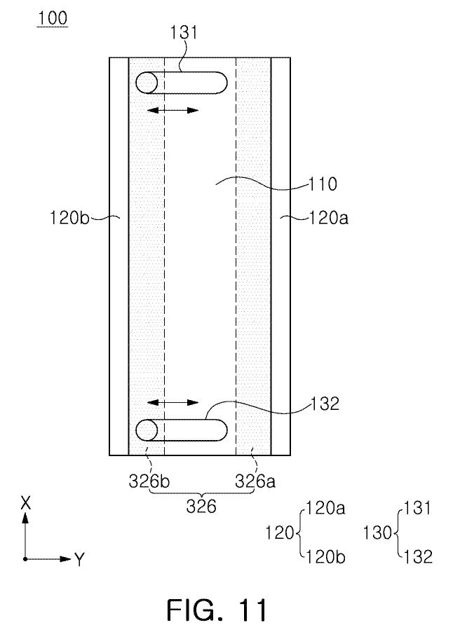

FIG. 10 is a side view illustrating a modified example of the carrier 320 illustrated in FIG. 8. FIG. 11 is a plan view illustrating the carrier 320 and the master block 100 illustrated in FIG. 10. FIGS. 10 and 11 illustrate modified examples of the carrier 320 and the master block 100.

Referring to FIGS. 10 and 11, the carrier 320 may include a linear transfer mechanism that fixes the cell 10a for folding via vacuum suction. The carrier 320 may include a support part 325 that supports the lower portion of the master block 100. The support part 325 may include an adsorption part 325a that penetrates the support part 325 and provides suction force to the cell 10a for folding. The adsorption part 325a serves as a passage through which air flows and is connected to a vacuum pump to fix the cell 10a for folding on the support part 325. The carrier 320 may include a positioning part 326 that adjusts or aligns the position of the suction target.

Compared to the master block 100 illustrated in FIG. 9, the master block 100 illustrated in FIG. 11 differs in the arrangement and shape of the fastening part 130. Among the description of the master block 100 illustrated in FIG. 9, the content excluding differences may be applied to the master block 100 illustrated in FIG. 11.

The fastening part 130 may include a first fastening part 131 and a second fastening part 132. The fastening part 130 may include at least two slot-shaped holes. The first fastening part 131 and the second fastening part 132 may each be formed as slot-shaped holes extending in the first direction (Y-axis direction).

The fastening part 130 of the master block 100 may be aligned by the positioning part 326 of the carrier 320. The positioning part 326 may include a first portion 326a that serves as a reference position and a second portion 326b used to position the fastening part 130 of the master block 100.

When at least two slot-shaped holes are provided in the fastening part 130, the position of the master block 100 may be aligned on the X-Y plane when installing the master block 100 on the carrier 320. Accordingly, the first reference surface 111 of the master block 100 may be aligned to be positioned on the X-Z plane, and the second reference surface 121 may be aligned to be positioned on the X-Y plane.

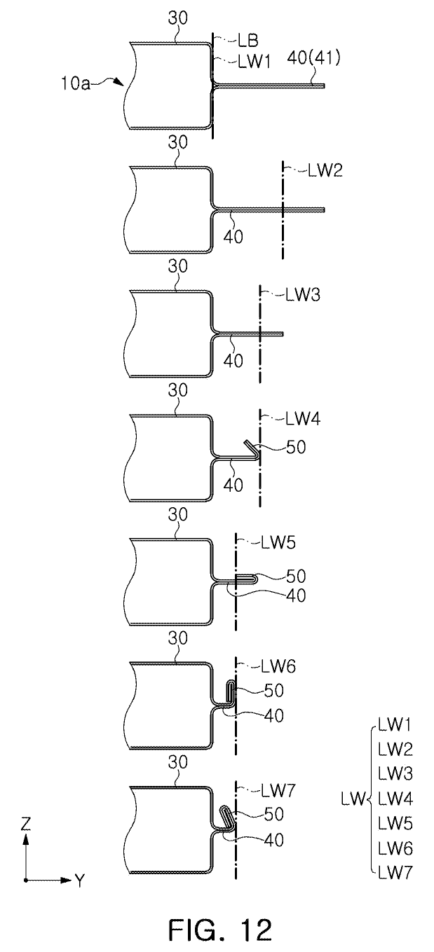

FIG. 12 is a schematic diagram illustrating the work reference line LW performed in each folding process part 200u.

FIG. 12 illustrates the work reference line LW of each folding process part 200u illustrated in FIG. 5 when processing the terrace 40 of the cell 10a for folding.

FIG. 12 illustrates, in the first direction (Y-axis direction), a work reference line LW1 of the cell alignment part 210, a work reference line LW2 of the cutting part 220, a work reference line LW3 of the pre-folding line forming part 230, a work reference line LW4 of the first folding part 240, a work reference line LW5 of the first pressing part 250, a work reference line LW6 of the second folding part 260, and a work reference line LW7 of the sizing part 280. The work reference line LW of the second pressing part 270 may be set to the same position as the work reference line LW7 of the sizing part 280.

The work reference line LW1 of the cell alignment part 210 may be set to the same position as the reference line LB of the cell 10a for folding. The work reference line LW of each folding process part 200u may have a preset position according to the size or design specifications of the cell 10a for folding. For example, in the first direction (Y-axis direction), the work reference line LW of each folding process part 200u may be set to a position spaced apart from the reference line LB of the cell 10a for folding by a preset distance.

As described with reference to FIG. 8, the reference line LB of the cell 10a for folding may correspond to the position LY of the first reference surface 111 of the master block 100. Accordingly, the position of each folding process part 200u may be adjusted so that the distance between the reference line LB of the cell 10a for folding and the work reference line LW of each folding process part 200u is equal to the distance between the position LY of the first reference surface 111 of the master block 100 and the work reference line LW of each folding process part 200u. In addition, the coordinate values provided from the position adjusting part 200p of each folding process part 200u may be stored in the storage part 330 and used for processing the terrace 40 of the cell 10a for folding by the controller 340.

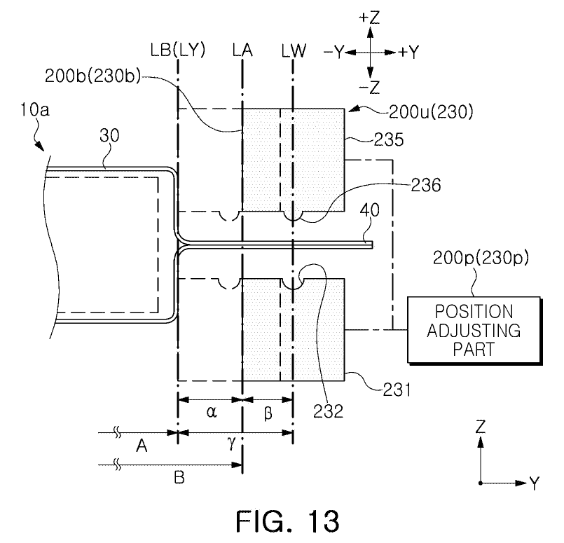

FIG. 13 is a side view illustrating the working position B of the pre-folding line forming part 230 for the cell 10a for folding.

FIG. 13 illustrates the pre-folding line forming part 230 as an example of a folding process part 200u. The pre-folding line forming part 230 may include a lower mold 231 and an upper mold 235. A forming groove 232 for forming the folding guideline 45 (FIG. 3) may be provided on the upper surface of the lower mold 231, and a forming protrusion 236 may be provided on the lower surface of the upper mold 235 to be inserted into the forming groove 232 for forming the folding guideline 45 (FIG. 3). A line extending from the center of the forming groove 232 and the forming protrusion 236 may correspond to the work reference line LW. The work reference line LW has a position spaced apart from the outer side surface 230b of the upper mold 235 by the first relative distance β in the +Y-axis direction. The pre-folding line forming part 230 may include a position adjusting part 230p that adjusts the positions of the lower mold 231 and the upper mold 235 in the first direction (Y-axis direction) and the second direction (Z-axis direction). After setting the working position B, the coordinate values provided by the position adjusting part 230p may be provided to the storage part 330 (FIG. 5).

The folding guide line 45 (FIG. 3) of the cell 10a for folding may be preset to a position spaced apart from the reference line LB of the cell 10a for folding by a second relative distance γ. Therefore, when the work reference line LW of the pre-folding line forming part 230 is positioned spaced apart from the reference line LB of the cell 10a for folding by the second relative distance γ, the folding guide line 45 (FIG. 3) may be formed at a preset precise location.

Referring to FIGS. 8 and 13 together, the position LY of the first reference surface 111 of the master block 100 may be set to the same position as the reference line LB of the cell 10a for folding. In other words, the reference line LB of the cell 10a for folding and the position LY of the first reference surface 111 of the master block 100 may have the same value.

As described with reference to FIG. 8, the reference origin A of the pre-folding line forming part 230 in the first direction (Y-axis direction) may be set to a position where the outer side surface 230 of the pre-folding line forming part 230 comes into contact with the first reference surface 111 of the master block 100 when the pre-folding line forming part 230 moves toward the first reference surface 111. That is, the Y-axis coordinate provided from the position adjusting part 230p at the position where the outer side surface 230 of the pre-folding line forming part 230 comes into contact with the first reference surface 111 of the master block 100 may be set as the reference origin A.

In addition, the offset value α in the pre-folding line forming part 230 may be set to a value obtained by subtracting the first relative distance β between the position LA of the outer side surface 230 of the pre-folding line forming part 230 and the work reference line LW from the second relative distance γ between the first reference surface 111 and the work reference line LW.

The working position B of the pre-folding line forming part 230 stored in the storage part 330 may be set to a coordinate value obtained by adding the reference origin A of the pre-folding line forming part 230 to the offset value α. Accordingly, the working position B of the pre-folding line forming part 230 may be fixed after moving the position of the pre-folding line forming part 230 to the coordinate value of the working position B through the position adjusting part 230p. Subsequently, by performing the process using the pre-folding line forming part 230, the folding guide line 45 (FIG. 3) may be formed at a preset precise location.

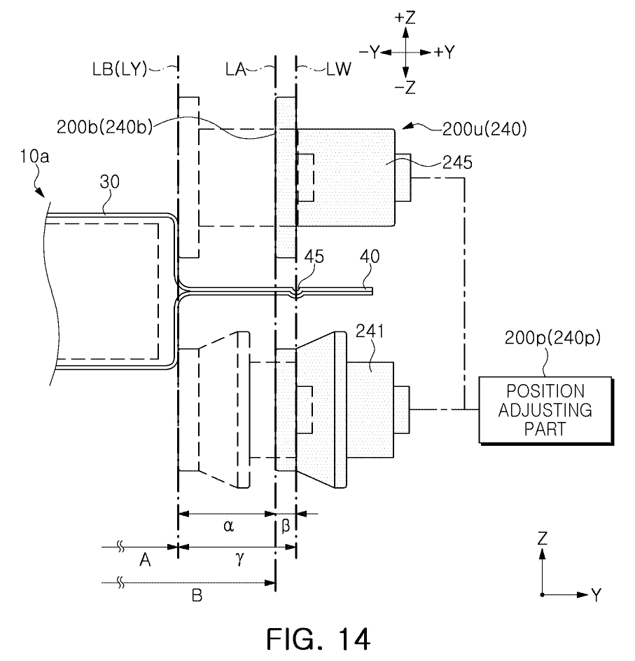

FIG. 14 is a side view illustrating the working position B of the first folding part 240 for the cell 10a for folding.

The first folding part 240 may include a plurality of roller pairs that sequentially increase the fold angle of the terrace 40. FIG. 14 illustrates the side surface of one of the plurality of roller pairs provided in the first folding part 240 as an example of the folding process part 200u.

The first folding part 240 may include the plurality of roller pairs. For example, the first folding part 240 may include a lower roller 241 and an upper roller 245. The terrace 40 of the cell 10a for folding may be folded between the lower roller 241 and the upper roller 245. When the process is performed through the pre-folding line forming part 230, the folding guide line 45 may be formed on the terrace 40 of the cell 10a for folding. The position where the folding guide line 45 passes may correspond to the work reference line LW. The work reference line LW has a position spaced apart from the outer side surface 240b of the upper roller 245 by the first relative distance β in the +Y-axis direction. The first folding part 240 may include a position adjusting part 240p that adjusts the positions of the lower roller 241 and the upper roller 245 in the first direction (Y-axis direction) and the second direction (Z-axis direction). After setting the working position B, the coordinate values provided by the position adjusting part 240p may be provided to the storage part 330 (FIG. 5).

The folding guide line 45 of the cell 10a for folding may be preset to a position spaced apart from the reference line LB of the cell 10a for folding by a second relative distance γ. Accordingly, when the work reference line LW of the first folding part 240 is performed at a position spaced apart from the reference line LB of the cell 10a for folding by the second relative distance γ, the folded portion 50 (FIG. 3) may be formed at the preset precise position.

Referring to FIGS. 8 and 14 together, the position LY of the first reference surface 111 of the master block 100 may be set to the same position as the reference line LB of the cell 10a for folding. In other words, the reference line LB of the cell 10a for folding and the position LY of the first reference surface 111 of the master block 100 may have the same value.

As described with reference to FIG. 8, the reference origin A of the first folding part 240 in the first direction (Y-axis direction) may be set to a position where the outer side surface 240b of the first folding part 240 comes into contact with the first reference surface 111 of the master block 100 when the first folding part 240 moves toward the first reference surface 111. That is, the Y-axis coordinate provided from the position adjusting part 240p at the position where the outer side surface 240b of the first folding part 240 comes into contact with the first reference surface 111 of the master block 100 may be set as the reference origin A.

In addition, the offset value α in the first folding part 240 may be set to a value obtained by subtracting the first relative distance β between the position LA of the outer side surface 240b of the first folding part 240 and the work reference line LW from the second relative distance γ between the first reference surface 111 and the work reference line LW.

The working position B of the first folding part 240 stored in the storage part 330 may be set to a coordinate value obtained by adding the reference origin A of the first folding part 240 to the offset value α. Therefore, the position of the first folding part 240 may be moved to the coordinate values of the working position B using the position adjusting part 240p, and then the working position B of the first folding part 240 may be fixed. Subsequently, by performing the process using the first folding part 240, the folded portion 50 (FIG. 3) may be formed at a preset precise position.

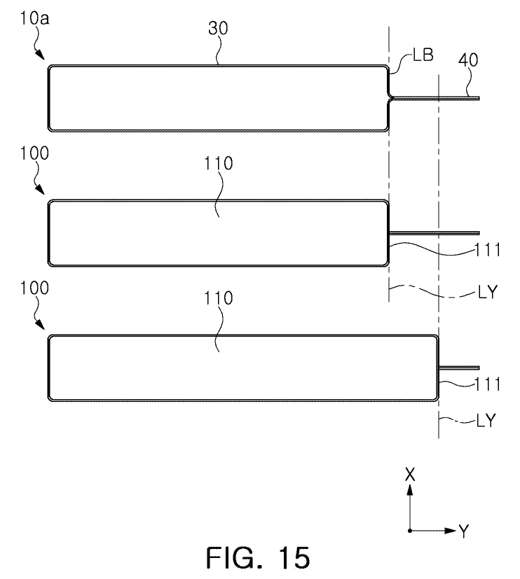

FIG. 15 is a schematic diagram illustrating the correspondence between the reference line LB of the cell 10a for folding and the first reference surface 111 of the master block 100.

The first reference surface 111 may correspond to the reference line LB positioned at the boundary area between the electrode accommodating portion 30 and the terrace 40 in the cell 10a for folding. In other words, the position LY of the first reference surface 111 may have the same value as the reference line LB of the cell 10a for folding.

The distance between the reference line LB of the cell 10a for folding and the work reference line LW, and the distance between the position LY of the first reference surface 111 of the master block 100 and the work reference line LW are each relative distances. Therefore, the position LY of the first reference surface 111 is not limited to the same value as the reference line LB of the cell 10a for folding. For example, when the position LY of the first reference surface 111 is set to a position spaced apart from the reference line LB of the cell 10a for folding by a predetermined distance, the relative distance between the position LY of the first reference surface 111 and the work reference line LW may be set by a position where the position LY of the first reference surface is spaced apart from the reference line LB.

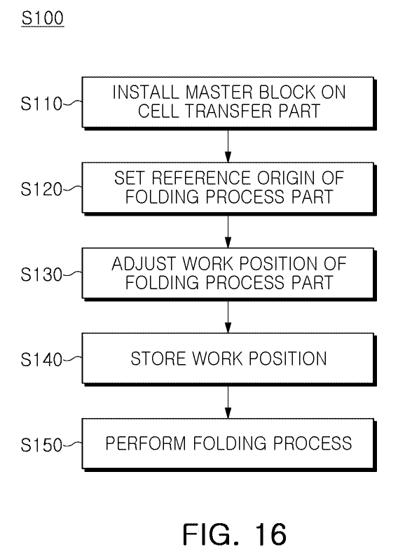

FIG. 16 is a flowchart illustrating a manufacturing method of a battery cell (S100) according to one embodiment.

Referring to FIGS. 5 through 15 and 16, the manufacturing method of a battery cell (S100) is described.

Referring to FIG. 16, the manufacturing method of a battery cell (S100) according to one embodiment may include a step (S110) of installing the master block 100 on the carrier 320 of a cell transfer part 310 that transfers the cell 10a for folding, a step (S120) of setting the reference origin A for each of the plurality of folding process parts 200u, a step (S130) of setting the working position B for each of the plurality of folding process parts 200u, a step (S140) of storing the working position B of each of the plurality of folding process parts 200u, and a step (S150) of forming the folding part 50 in the cell 10a for folding by controlling the driving of each of the plurality of folding process parts 200u at each of the working positions B stored in the step (S140) of storing the working position B.

As described with reference to FIGS. 5 through 11, the step (S110) of installing the master block 100 may include installing the master block 100 on the carrier 320 of the cell transfer part 310. The master block 100 may be fixed to the carrier 320 while being aligned to have a preset position. The master block 100 may be installed on the carrier 320 instead of the cell 10a for folding. When installing the master block 100 on the carrier 320, the master block 100 may be aligned to a preset position on the X-Y plane.

The master block 100 may include a body 110 having a first reference surface 111 on its side surface, and an extension portion 120 extending in a first direction (Y-axis direction) from the first reference surface 111 of the body 110. The first reference surface 111 of the master block 100 may be aligned to be positioned on the X-Z plane, and the second reference surface 121 of the master block 100 may be aligned to be positioned on the X-Y plane. The master block 100 may move to a position facing each folding process part 200u by the cell transfer part 310 (FIG. 5).

The step (S110) of installing the master block 100 may align the first reference surface 111 to be perpendicular to the first direction (Y-axis direction) by using at least two slot-shaped holes provided in the master block 100. When at least two slot-shaped holes are provided in the fastening part 130, the position of the master block 100 may be aligned on the X-Y plane when installing the master block 100 on the carrier 320. Accordingly, the first reference surface 111 of the master block 100 may be aligned to be positioned on the X-Z plane, and the second reference surface 121 may be aligned to be positioned on the X-Y plane.

As described with reference to FIGS. 7A through 8, the step (S120) of setting the reference origin A may be performed for each folding process part 200u. The step (S120) of setting the reference origin A may be set by adjusting the position of the folding process part 200u through the position adjusting part 200p of each folding process part 200u. In the first direction (Y-axis direction), the reference origin A of each folding process part 200u may be set to a position where the outer side surface 200b of each folding process part 200u comes into contact with the first reference surface 111 when each folding process part 200u moves toward the first reference surface 111.

That is, the step (S120) of setting the reference origin A in the first direction (Y-axis direction) may include a process of moving each folding process part 200u toward the master block 100 mounted on the carrier 320 to bring each folding process part 200u into contact with the master block 100.

The reference origin A in the first direction (Y-axis direction) may include a Y-axis coordinate obtained when positioning the folding process part 200u through the position adjusting part 200p. For example, the reference origin A may include a Y-axis coordinate provided by the position adjusting part 200p in the state in which the outer side surface 200b of the folding process part 200u comes into contact with the first reference surface 111 of the master block 100.

The step (S120) of setting the reference origin A may be performed by moving each folding process part 200u toward the first reference surface 111 in the first direction (Y-axis direction) and setting the position where the outer side surface 200b of each folding process part 200u comes into contact with the first reference surface 111 as the reference origin A of each folding process part 200u.

In the second direction (Z-axis direction), the reference origin may be set to a position at which each folding process part 200u comes into contact with the second reference surface 121 when each folding process part 200u moves toward the second reference surface 121. The reference origin in the second direction (Z-axis direction) may include a Z-axis coordinate obtained when positioning the folding process part 200u through the position adjusting part 200p.

The reference origin provided by the position adjusting part 200p obtained when each folding process part 200u is in contact with the first reference surface 111 and/or the second reference surface 121 of the master block 100 may be stored in the storage part 330 (FIG. 5).

As described with reference to FIGS. 7A through 8, the step (S130) of setting the working position B may be performed for each of the plurality of folding process parts 200u. The working position B of each folding process part 200u in the first direction (Y-axis direction) may be set by considering the distance between the first reference surface 111 and the work reference line LW on which the processing of the terrace 40 is performed. In the first direction (Y-axis direction), the working position B of each folding process part 200u may be set by the reference origin A of each folding process part 200u and the preset offset value α for each folding process part 200u.

The step (S130) of setting the working position B may set the working position B of each folding process part 200u to a value obtained by adding the reference origin A of each folding process part 200u and the preset offset value α for each folding process part 200u.

In the first direction (Y-axis direction), the preset offset value α for each folding process part 200u may be set to a value obtained by subtracting the distance between the position LA of the outer side surface 200b of each folding process part 200u and the work reference line LW from the distance between the first reference surface 111 and the work reference line LW.

Meanwhile, in the second direction (Z-axis direction), the working position of each folding process part 200u may be set to a position at which each folding process part 200u comes into contact with the second reference surface 121.

The step (S130) of setting the working position B may include a step of adjusting the position of each folding process part 200u in the first direction (Y-axis direction) in which each folding process part 200u approaches the master block 100, and a step of adjusting the position of each folding process part 200u in the second direction (Z-axis direction) in the height direction of the master block 100.

The step (S140) of storing the working position B may store the working position B of each folding process part 200u in the storage part 330 (FIG. 5). The working position B of each folding process part 200u stored in the storage part 330 may be a relative coordinate value provided by each position adjusting part 200p.

The step (S150) of forming the folded portion 50 may control the driving of the plurality of folding process parts 200u at each working position B stored in the step (S140) of storing the working position B. The step (S150) of forming a folded portion 50 may control the driving of the cell transfer part 310 to transfer the cell 10a for folding whose work has been completed in one folding process part 200u to the folding process part 200u of the next step.

Since each folding process part 200u is adjusted to the preset working position B, the quality of the folded portion 50 formed on the battery cell 10 may be maintained consistently. Furthermore, even when the folding apparatus 200 is installed on a plurality of production lines, variations in the working position setting for each production line may be reduced or minimized.

According to one embodiment of the present disclosure, it is possible to standardize the setting of working positions for each of the plurality of folding process parts.

According to one embodiment of the present disclosure, it is possible to standardize the setting operation of working positions for the plurality of folding process parts in the plurality of production lines. Accordingly, even when the folding apparatus is installed on each of the plurality of production lines, it is possible to reduce or minimize variations occurring during the setting of working positions for each production line.

According to one embodiment of the present disclosure, it is possible to shorten the time required to set working positions for each of the plurality of folding process parts.

According to one embodiment of the present disclosure, it is possible to consistently maintain the quality of the folded portion formed in the battery cell.

According to one embodiment of the present disclosure, when the abnormality occurs in the folding process, it is possible to easily identify the cause of the abnormality through the comparison between the production lines.

Only specific examples of implementations of certain embodiments are described. Variations, improvements and enhancements of the disclosed embodiments and other embodiments may be made based on the disclosure of this patent document.

What is claimed is:

1. A manufacturing apparatus of a battery cell, comprising:
a cell transfer part including a carrier provided so that a cell for folding is mounted on the carrier;
a folding apparatus including a plurality of folding process parts for folding a terrace of the cell for folding transferred by the cell transfer part;
a master block mounted on the carrier and structured to adjust a reference origin of each of the plurality of folding process parts;
a storage part storing a working position of each of the plurality of folding process parts; and
a controller controlling driving of the cell transfer part and the plurality of folding process parts to process the terrace of the cell for folding, with positions of the plurality of folding process parts set to a respective working positions stored in the storage part,
wherein the working position of each folding process part stored in the storage part is set by the reference origin of each folding process part and a preset offset value for each folding process part, and
the reference origin of each folding process part is set by moving each folding process part toward the master block mounted on the carrier and bringing each folding process part into contact with the master block.

2. The manufacturing apparatus of claim 1, wherein the master block includes a body having a first reference surface on a side surface and an extension portion extending from the first reference surface of the body in a first direction.

3. The manufacturing apparatus of claim 2, wherein the reference origin of each folding process part in the first direction is set to a position in which each folding process part moves toward the first reference surface and an outer side surface of each folding process part contacts the first reference surface.

4. The manufacturing apparatus of claim 3, wherein the working position of each folding process part stored in the storage part is set to a value obtained by adding the reference origin of each folding process part to the preset offset value for each folding process part.

5. The manufacturing apparatus of claim 4, wherein the working position of each folding process part in the first direction is set by considering a distance between the first reference surface and a work reference line where the terrace is processed, and
the preset offset value for each folding process part is set to a value obtained by subtracting the distance between a position of the outer side surface and the work reference line of each folding process part from the distance between the first reference surface and the work reference line.

6. The manufacturing apparatus of claim 2, wherein the master block has a second reference surface in a second direction, perpendicular to the first direction, on a lower surface or an upper surface of the extension portion.

7. The manufacturing apparatus of claim 2, wherein the extension portion extends from the body at a position spaced apart from a lower surface of the body by a first height, and
the first height has a value less than a thickness of the body.

8. The manufacturing apparatus of claim 2, wherein the extension portion extends to both sides of the body in the first direction, respectively.

9. The manufacturing apparatus of claim 1, wherein the master block includes a fastening part that is fastened to the carrier, and
the fastening part includes at least two slot-shaped holes.

10. The manufacturing apparatus of claim 1, wherein each folding process part includes a position adjusting part that adjusts a position in a first direction approaching the master block and a position in a second direction corresponding to a height direction of the master block.

11. The manufacturing apparatus of claim 1, wherein the plurality of folding process parts includes at least one of a cell alignment part that aligns the cell for folding, a cutting part that cuts the terrace of the cell for folding to a preset length, a pre-folding line forming part forming a folding guide line on the terrace of the cell for folding, a first folding part that folds the terrace of the cell for folding at a first angle, a first pressing part that presses a folded portion folded at the first angle, a second folding part that folds the terrace of the cell for folding at a second angle, a second pressing part that presses a folded portion folded at the second angle, and a sizing part that reduces an external size of the folded portion folded at the second angle.

12. A manufacturing method of a battery cell, comprising:
installing a master block on a carrier of a cell transfer part that transfers a cell for folding;
setting a reference origin for each of a plurality of folding process parts;
setting working positions for each of the plurality of folding process parts;
storing the working positions of each of the plurality of folding process parts; and
controlling driving of each of the plurality of folding process parts at each working position stored in the storing of the working position to form a folded portion in the cell for folding,
wherein the setting of the reference origin includes moving each folding process part toward the master block mounted on the carrier to bringing each folding process part into contact with the master block.

13. The manufacturing method of claim 12, wherein the master block includes a body having a first reference surface on a side surface and an extension portion extending from the first reference surface of the body in a first direction, and
in the setting of the reference origin, each folding process part moves toward the first reference surface in the first direction and a position where an outer side surface of each folding process part contacts the first reference surface is set as the reference origin of each folding process part.

14. The manufacturing method of claim 13, wherein, in the setting of the working position, a value obtained by adding the reference origin of each folding process part and a preset offset value for each folding process part is set to the working position of each folding process part.

15. The manufacturing method of claim 13, wherein, in the installing of the master block, the first reference surface is aligned to be perpendicular to the first direction using at least two slot-shaped holes provided in the master block.

16. The manufacturing method of claim 12, wherein the setting of the working position includes adjusting the position of each folding process part in a first direction in which each folding process part approaches the master block and adjusting the position of each folding process part in a second direction which is a height direction of the master block.

17. A master block mounted on a carrier that transfers a cell for folding to set a working position of a folding process part that folds a terrace of the cell for folding, the master block comprising:
a body having a first reference surface on a side surface of the body; and
an extension portion extending from the first reference surface of the body in a first direction,
wherein the extension portion has a second reference surface on a lower surface or an upper surface in a second direction, perpendicular to the first direction.
